(19) United States
(12) Patent Application Publication
(10) Pub. No.: US 2011/0233247 A1
(43) Pub. Date: Sep. 29, 2011

(54) SADDLE BAG AND MOTORCYCLE HAVING THE SAME

(76) Inventor: Izumi KANAZAWA, Saitama (JP)

(21) Appl. No.: 13/069,577

(22) Filed: Mar. 23, 2011

(30) Foreign Application Priority Data
Mar. 26, 2010 (JP) 2010-073446

(51) Int. Cl. B62J 9/00

(52) U.S. Cl. 224/413

(57) ABSTRACT

A saddle bag that can efficiently achieve required storage capacity and that is easy to use for easy loading and unloading of luggage. A saddle bag is disposed at a predetermined position in a vehicle, such as a motorcycle, and is configured to store articles. A storage unit formed substantially into a box shape to be capable of storing articles therein is supported inside a case unit for covering the storage unit via a slide mechanism. The storage unit can slidingly move between a bag closed position in which the storage unit is housed and closed in the case unit and a bag open position in which the storage unit is exposed from the case unit.

### CROSS-REFERENCE TO RELATED APPLICATIONS

The present application claims priority under 35 USC 119 to Japanese Patent Application No. 2010-073446 filed on Mar. 26, 2010 the entire contents of which are hereby incorporated by reference.

### BACKGROUND OF THE INVENTION

1. Field of the Invention

The present invention relates to a saddle bag mounted on a vehicle body of a motorcycle.

2. Description of Background Art

A motorcycle is known that includes saddle bags for accommodating luggage that are disposed on both sides of part (typically in a rear portion) of the vehicle body. For example, a motorcycle as disclosed in Japanese Patent Publication No. Sho 62-91383 is structured to include a top box on an upper surface of a rear portion of a vehicle body and saddle bags disposed downwardly of the top box on both sides of the vehicle body. Each of the saddle bags is attached via a mounting bracket so as to bulge from a corresponding side surface. The saddle bag includes a box-like bag main unit with a vertically openable lid member on an upper side thereof.

In addition, a saddle bag structure is disclosed in JP-T-2008-505015 that includes, in a mounted condition, a bag inside portion disposed on the vehicle side and a bag outside portion disposed on the outside of the bag inside portion with the bag outside portion being rotatable relative to the bag inside portion so as to open or close the saddle bag. The saddle bag further includes a bag intermediate member between the bag inside portion and the bag outside portion with the bag intermediate member being a bellows-like, extensible, flexible member.

The related art saddle bag disclosed in Japanese Patent Publication No. Sho 62-91383 can be opened or closed only if the top box does not overlap the saddle bag in the vertical direction. This imposes restrictions on the size of the top box, when a need for enlarging the saddle bag is to be met. Meanwhile, the bulging size of the saddle bag in a vehicle width direction affects the vehicle width. Therefore, in the configuration of Japanese Patent Publication No. Sho 62-91383, a required width in the vehicle lateral direction cannot be secured without making the top box small and thus a large storage capacity cannot be achieved.

If a saddle bag includes a bellows-like bag intermediate member that functions when a bag outside portion is rotated to be open as in the related art saddle bag disclosed in JP-T-2008-505015, there is an improvement in terms of the size of the opening when the bag outside portion is opened. However, with a saddle bag on the side inclined to a lower position when a side stand is deployed (i.e. the saddle bag on the left side if the side stand is disposed on the left-hand side), the saddle bag operating procedure poses a problem in that, for example, the saddle bag needs to be opened with articles stored inside held by hand to prevent them from falling, or the saddle bag can only be closed if the articles are suitably pushed therein. Unfortunately, the saddle bag of this type is clumsy to use, since it needs special attention to ensure that the articles do not drop out by always being kept within the storage capacity in terms of both the number and size of the articles to be stored therein.

### SUMMARY AND OBJECTS OF THE INVENTION

The present invention has been made to solve the foregoing problems and it is an object of an embodiment of the present invention to provide a saddle bag that can efficiently achieve required storage capacity and that is easy to use for easy loading and unloading of luggage.

To achieve the foregoing object, according to an embodiment of the present invention a saddle bag is disposed at a predetermined position in a vehicle and is configured to store articles. The saddle bag includes: a storage unit formed substantially into a box shape to be capable of storing articles therein; a case unit for covering the storage unit; and a slide mechanism via which the storage unit is supported on an inside of the case unit. The storage unit can slidingly move between a bag closed position in which the storage unit is housed and closed in the case unit and a bag open position in which the storage unit is exposed from the case unit.

According to an embodiment of the present invention, the storage unit includes a bottom wall surface, left and right side wall surfaces, a rear side wall surface, and an outer wall surface. The slide mechanism is disposed on an outside of each of the left and right side wall surfaces or of each of left and right sides of the bottom wall surface.

According to an embodiment of the present invention, the storage unit includes a damper mechanism that absorbs the impact of movement along a sliding motion direction.

According to an embodiment of the present invention, the saddle bag further includes small-sized storage units independent of the storage unit, disposed in a gap between the case unit and an outside of the storage unit.

According to an embodiment of the present invention, the small-sized storage units have openable lid portions.

According to an embodiment of the present invention, the storage unit includes a pair of saddle bags that slidingly open laterally in a vehicle lateral direction.

According to an embodiment of the present invention, the slide mechanism allows the storage unit to slidingly move between the bag closed position in which the storage unit is housed and closed in the case unit and the bag open position in which the storage unit is exposed from the case unit. As such, the storage unit is opened or closed in a box-like condition and in a condition of being steadily held, which facilitates loading and unloading of articles regardless of a condition in which the vehicle is stationary.

According to an embodiment of the present invention, the storage unit includes the slide mechanisms disposed on both sides thereof, which ensures smooth opening/closing. If the slide mechanisms are disposed on the side of the bottom wall surface, the storage unit can have a maximum opening.

According to an embodiment of the present invention, the damper mechanism not only ensures smooth opening/closing, but also absorbs impact during the opening/closing. This enhances operability and prevents the articles stored in the storage unit from dropping out.

According to an embodiment of the present invention, the box-like shape of the storage unit combined with the small-sized storage units allows the case unit to be designed freely without being dependent on the box shape of the storage unit. This ensures an efficient storage space.

According to an embodiment of the present invention, the small-sized storage units have openable lid portions. This prevents articles stored in the small-sized storage units from dropping out.

According to an embodiment of the present invention, the storage unit includes a pair of saddle bags that slidingly open laterally in the vehicle lateral direction. Therefore, even if the vehicle is mounted with a trunk case (top box) having a capacity so large so as to cover the upper side of the case unit, the trunk case does not impede articles from being loaded or unloaded to/from the saddle bag. In addition, the storage unit is opened or closed in a box-like condition and in a condition of being steadily held. Even when the motorcycle is in an inclined stationary state with a side stand deployed, the articles stored in the saddle bag are reliably held inside the storage unit, which prevents the articles from dropping out when the storage unit is slid open. Further, since the storage unit is steadily held by the slide mechanisms, there is no need to support the storage unit with one hand when an article is loaded therein. This enhances operability.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a left side elevational view showing a motorcycle according to an embodiment of the present invention;

FIG. 2 is a side elevational view showing a saddle bag attached to the motorcycle shown in FIG. 1 in a closed position;

FIG. 3 is a perspective view showing the saddle bag attached to the motorcycle shown in FIG. 1 in an open position;

FIG. 4 is a partial exploded perspective view showing a slide mechanism of the saddle bag according to the embodiment of the present invention;

FIG. 5 is a plan view showing a back surface side of a bottom portion of a storage unit in the saddle bag according to the embodiment of the present invention; and

FIG. 6 is a partial schematic plan view showing a rear portion of the motorcycle according to the embodiment of the present invention.

### DETAILED DESCRIPTION OF THE PREFERRED EMBODIMENTS

A specific embodiment to which the present invention is applied will be described.

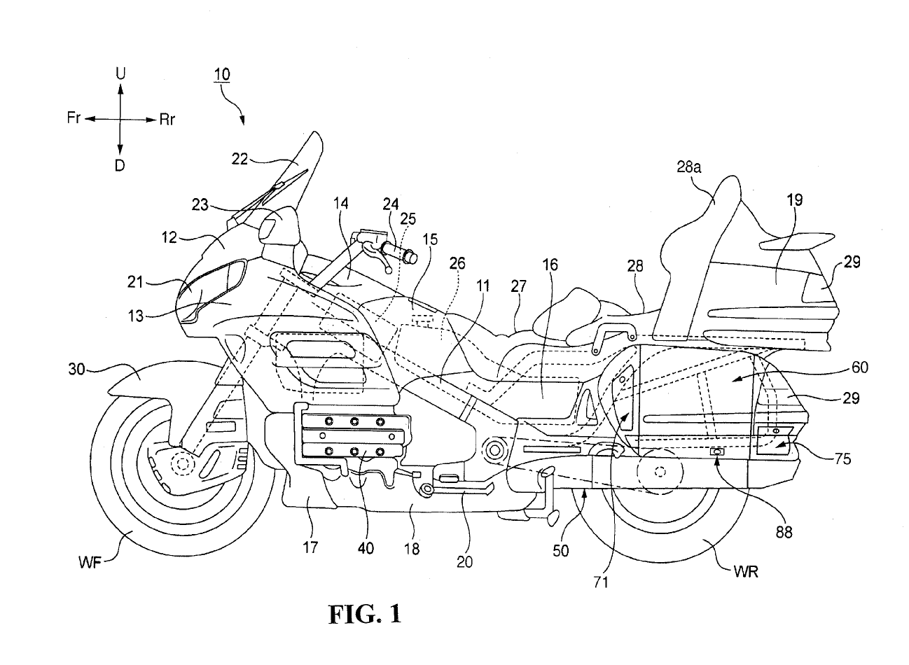

The embodiment of the present invention will be described in detail below with reference to FIGS. 1 to 6. The embodiment is applied to a motorcycle.

The drawings should be viewed in the direction of reference numerals. Throughout the descriptions given hereunder, expressions indicating directions including front and rear, right and left, and upper and lower mean the same directions as those as viewed from a rider. In the drawings, an arrow Fr indicates forward of the vehicle, an arrow Rr indicates rearward of the vehicle, an arrow L indicates leftward of the vehicle, an arrow R indicates rightward of the vehicle, an arrow U indicates upward of the vehicle, and an arrow D indicates downward of the vehicle.

Referring to FIG. 1, a motorcycle (saddle riding type vehicle) 10 according to the embodiment of the present invention includes a front top cover 12, a front side cover 13, a top bridge 14, a center cover 15, a rear side cover 16, a front lower cover 17, a rear lower cover 18, and a pair of left and right saddle bags 60. More specifically, the front top cover 12 covers forwardly of a vehicle body frame 11. The front side cover 13 covers sideways of a front portion of the vehicle body frame 11. The top bridge 14 and the center cover 15 cover upwardly of the front portion of the vehicle body frame 11. The rear side cover 16 covers sideways of a rear portion of the vehicle body frame 11. The front lower cover 17 covers forwardly of an engine 40. The rear lower cover 18 covers downwardly of the engine 40. The pair of left and right saddle bags 60 is disposed to sandwich the relatively large trunk case 19 and a rear wheel WR disposed on the rear portion of the vehicle body frame 11. The motorcycle 10 further includes a tail light 29 disposed on a rear surface of each of the trunk case 19 and the saddle bags 60.

Referring to FIG. 1, the motorcycle 10 further includes a headlight 21 that is flush with the surface of the front top cover 12, a windshield 22 disposed upwardly of the front top cover 12, and a side mirror 23 on each side of the windshield 22. In addition, the motorcycle 10 includes a front fender 30, an air cleaner 25, a fuel tank 26, a rider's seat 27, and a pillion 28. More specifically, the front fender 30 is disposed on a front fork to which a steering handlebar 24 is connected and covers a front wheel WF. The air cleaner 25 is disposed forwardly, and the fuel tank 26 is disposed downwardly, of the rider's seat 27. The pillion 28 including a seatback portion 28a is disposed rearwardly of the rider's seat 27.

An exhaust system 50 is connected to the engine 40. The exhaust system 50 includes a pair of left and right exhaust pipes connected to an exhaust port not shown of the engine 40 and a muffler that is connected to a downstream end of each of the left and right exhaust pipes.

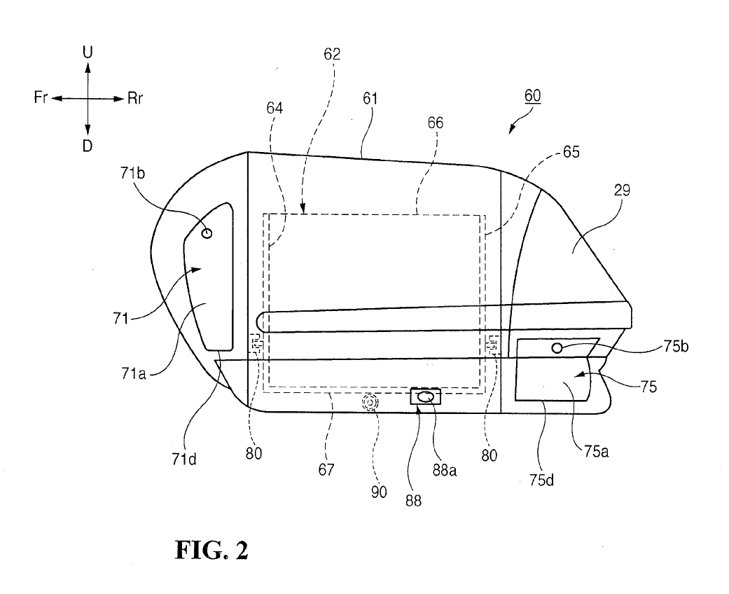

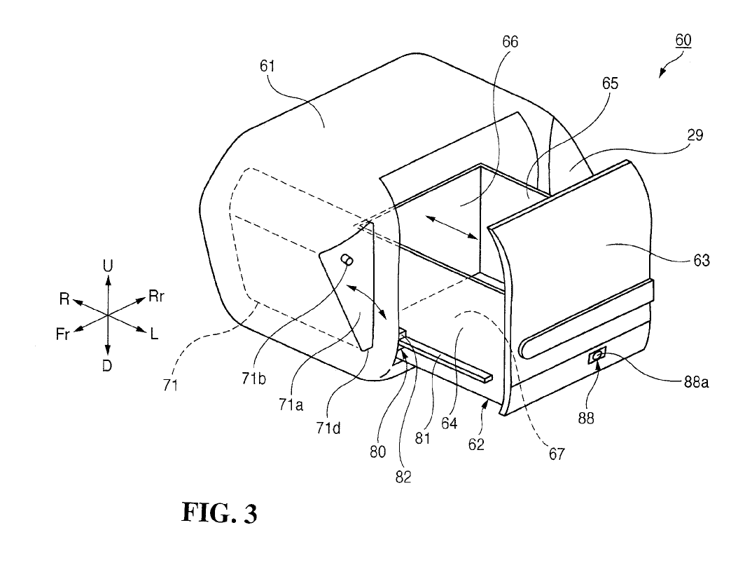

Referring to FIGS. 2 and 3, the saddle bag 60 according to the embodiment of the present invention includes a storage unit 62 that is formed substantially into a box shape in which articles can be stored. The saddle bag 60 is thus structured to support the storage unit 62 with an inside of a case unit 61 that covers the storage unit 62 via a slide mechanism 80. More specifically, the storage unit 62 can slidingly move between a bag closed position in which the storage unit 62 is housed in the case unit 61 (in which the saddle bag 60 is closed as shown in FIG. 2) and a bag open position in which the storage unit 62 is slid out of the case unit 61 (in which the saddle bag 60 is open as shown in FIG. 3). As such, the storage unit 62 is opened or closed in a box-like condition and in a condition of being steadily held as will be described later. This facilitates loading and unloading of articles regardless of the condition in which the motorcycle 10 is stationary.

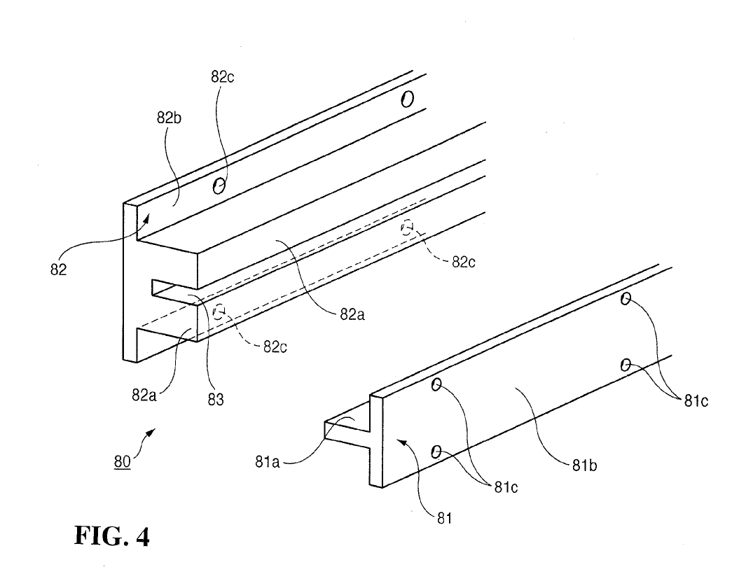

The storage unit 62 is formed as a box-like container including a bottom wall surface 67, a left side wall surface 64, a right side wall surface 65, a rear side wall surface 66, and an outer wall surface 63. The storage unit 62, being a sturdy, box-like storage structure as described above, reliably stores and holds articles stored therein. In addition, the slide mechanism 80 is disposed on an outside of each of the left side wall surface 64 and the right side wall surface 65. The slide mechanism 80 includes, as shown, for example, in FIG. 4, a slider section 81 affixed to each of the left side wall surface 64 and the right side wall surface 65 and a rail section 82 fixed to an inside of the case unit 61 or, for example, a vehicle support bracket.

The slider section 81 is formed into a T shape in a transverse section, including a sliding portion 81a and a mounting portion 81b. The slider section 81 is fixed to the left side wall surface 64 and the right side wall surface 65 with, for example, screws via mounting screw holes 81c. The rail section 82 includes a pair of protrusions 82a, 82a that constitute a rail groove 83 and a mounting portion 82b having mounting screw holes 82c. The rail section 82 is fixed to the case unit 61 or, for example, a vehicle bracket.

The storage unit 62 can be slidingly moved relative to the case unit 61 in a longitudinal direction of the slide mechanism 80 (lateral direction of the vehicle) when the sliding portion 81a is fitted into the rail groove 83. Thanks to the slide mechanisms 80 disposed on both sides of the storage unit 62, the storage unit 62 can be smoothly opened or closed in a steadily held condition.

In the embodiment of the present invention, the slide mechanisms 80 are disposed on both lateral sides of the storage unit 62. The slide mechanisms 80 may nonetheless be disposed at, for example, positions close to either lateral side of the bottom wall surface 67 of the storage unit 62. In this case, the storage unit 62 can have a maximum opening because of margins outside the left side wall surface 64 and the right side wall surface 65, not occupied by the slide mechanisms 80.

In the embodiment of the present invention, the storage unit 62 includes a damper mechanism 90 that absorbs impact of movement along a sliding motion direction.

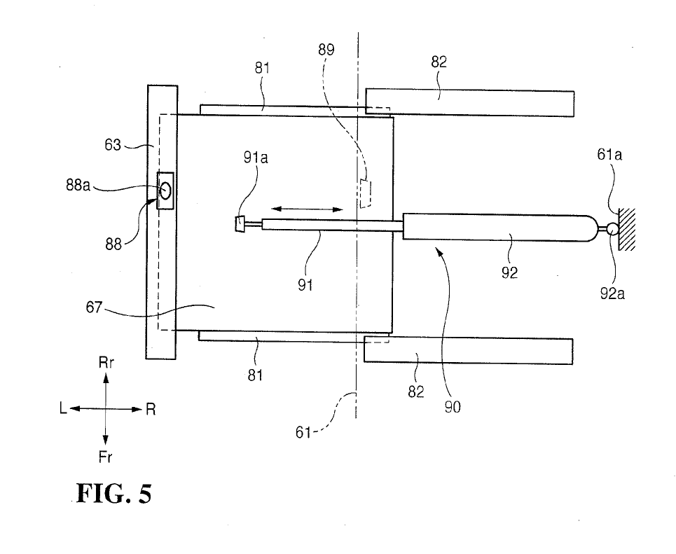

Referring to FIG. 5, the damper mechanism 90 is a well-known type including, for example, an inner shaft member 91 moving inside an outer shaft member 92. The inner shaft member 91 has a first end journaled at a distal end connecting portion 91a on the back side of the bottom wall surface 67. The outer shaft member 92 has a first end journaled at a frame portion 61a of the case unit 61 or a proximal end connecting portion 92a of, for example, a bracket on the vehicle main body. If the storage unit 62 has a mechanism such as this damper mechanism 90, impact involved in opening or closing the storage unit 62 can be absorbed to ensure smooth sliding motion.

In addition, a locking section 88 is disposed on the outer wall surface 63 of the storage unit 62. The locking section 88 may incorporate any of various types of well-known locking structures and details thereof will be omitted. In operation, for example, the structure may be suitably locked in a lock portion 89 disposed on the case unit 61. When, for example, the storage unit 62 is to be slid out from the bag closed position, a button 88a on an outer surface of the locking section 88 is pressed to unlock and slide out the storage unit 62; when the storage unit 62 is to be slid into the bag closed position, the outer wall surface 63 is pushed all the way, so that the locking section 88 is locked in the lock portion 89.

Referring to FIGS. 2 and 3, the saddle bag 60 according to the embodiment of the present invention further includes small-sized storage units 71, 75 independent of the storage unit 62, disposed in a gap between the case unit 61 and the outside of the storage unit 62. More specifically, the storage unit 62 is a box shape; if the case unit 61 bulges in the vehicle longitudinal direction as in the embodiment of the present invention, therefore, there are spaces available at the front and rear of the storage unit 62 and the small-sized storage units 71, 75 fill these spaces. The small-sized storage units 71, 75 have openable lid portions 71a, 75a, respectively, to prevent articles stored therein from dropping out.

The lid portions 71a, 75a are adapted to be pivotally openable about hinge portions 71d, 75d, respectively, disposed on lower sides thereof. The lid portions 71a, 75a may therefore be opened or closed by operating, for example, knob portions 71b, 75b and suitably locked in a closed position with locking means not shown. As such, the lid portions 71a, 75a open on upper sides thereof, which facilitates loading and unloading of articles to/from the small-sized storage units 71, 75.

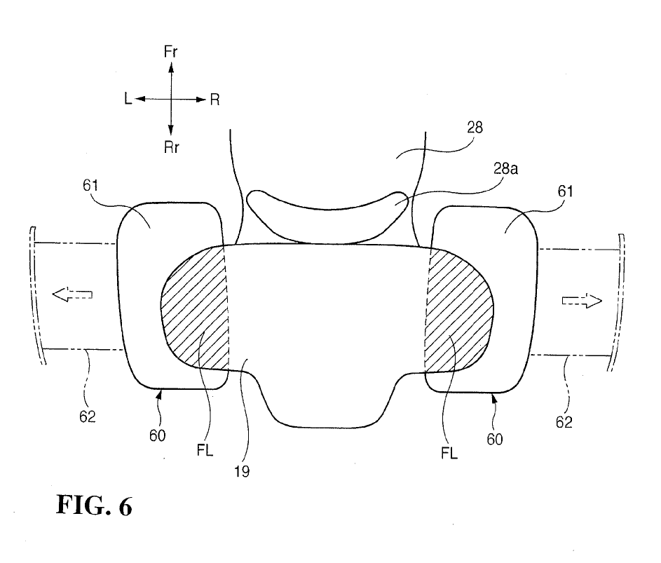

In the saddle bag 60 according to the embodiment of the present invention, the storage unit 62 is slidingly open laterally in the vehicle lateral direction as shown in FIG. 6. The storage unit 62 is open in the vehicle lateral direction in a steadily held condition as illustrated in FIG. 6. Therefore, even with overlapping zones FL (shown hatched in FIG. 6) in which the two saddle bags 60 reach under the trunk case 19, the trunk case 19 does not interfere at all with loading and unloading of articles. More specifically, the space under the trunk case 19 can be effectively used, so that effects can be achieved of securing a storage space and inhibiting the vehicle width from increasing.

In addition, even when the motorcycle 10 is in an inclined stationary state with a side stand 20 (see FIG. 1) deployed, the articles stored in the saddle bag 60 are reliably held inside the storage unit 62, which prevents the articles from dropping out when the storage unit 62 is slid open. Further, the storage unit 62 is steadily held by the slide mechanisms 80. This eliminates the need for supporting the storage unit 62 with one hand when an article is loaded therein, enhancing operability.

While the present invention has been particularly shown and described with reference to the preferred embodiment, it will be understood by those skilled in the art that various changes in form and detail may be made therein without departing from the spirit and scope of the invention. For example, the saddle bag may be shaped differently, and the damper mechanism and the locking mechanism may be arranged differently as necessary. In addition, with the slide mechanism, the structure shown in FIG. 4 is not the only possible arrangement and any other well-known slide mechanism may be suitably applied.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A saddle bag disposed at a predetermined position in a vehicle and configured to store articles, comprising:
a storage unit formed substantially into a box shape to be capable of storing articles therein;
a case unit for covering the storage unit; and
a slide mechanism via which the storage unit is supported on an inside of the case unit;
wherein the storage unit is manually slidingly movable between a closed position in which the storage unit is housed and closed in the case unit and an opened position in which the storage unit is exposed from the case unit.

2. The saddle bag according to claim 1, wherein:
the storage unit includes a bottom wall surface, left and right side wall surfaces, a rear side wall surface, and an outer wall surface; and
the slide mechanism is disposed on an outside of each of the left and right side wall surfaces or of each of left and right sides of the bottom wall surface.

3. The saddle bag according to claim 1, wherein the storage unit includes a damper mechanism that absorbs impact of movement along a sliding motion direction.

4. The saddle bag according to claim 2, wherein the storage unit includes a damper mechanism that absorbs impact of movement along a sliding motion direction.

5. The saddle bag according to claim 1, further comprising:
small-sized storage units independent of the storage unit, disposed in a gap between the case unit and an outside of the storage unit.

6. The saddle bag according to claim 2, further comprising:
small-sized storage units independent of the storage unit, disposed in a gap between the case unit and an outside of the storage unit.

7. The saddle bag according to claim 3, further comprising:
small-sized storage units independent of the storage unit, disposed in a gap between the case unit and an outside of the storage unit.

8. The saddle bag according to claim 5, wherein the small-sized storage units have openable lid portions.

9. A saddle bag for a motorcycle comprising the saddle bag according to claim 1, said vehicle being a motorcycle.

10. The saddle bag according to claim 9, wherein the storage unit includes a pair of saddle bags that slidingly open laterally in a vehicle lateral direction.

11. A saddle bag adapted to be mounted on a vehicle for storing articles, comprising:
a substantially box shaped storage unit adapted for storing articles therein;
case unit for covering the storage unit; and
slide mechanism for supporting the storage unit within the case unit;
said storage unit being slidingly moved between a closed position in which the storage unit is housed and closed in the case unit and an opened position in which the storage unit is exposed from the case unit.

12. The saddle bag according to claim 11, wherein:
the storage unit includes a bottom wall surface, left and right side wall surfaces, a rear side wall surface, and an outer wall surface; and
the slide mechanism is disposed on an outside of each of the left and right side wall surfaces or of each of left and right sides of the bottom wall surface.

13. The saddle bag according to claim 11, wherein the storage unit includes a damper mechanism for absorbing impact of movement along a sliding motion direction.

14. The saddle bag according to claim 12, wherein the storage unit includes a damper mechanism for absorbing impact of movement along a sliding motion direction.

15. The saddle bag according to claim 11, further comprising:
small-sized storage units independent of the storage unit, disposed in a gap between the case unit and an outside of the storage unit.

16. The saddle bag according to claim 12, further comprising:
small-sized storage units independent of the storage unit, disposed in a gap between the case unit and an outside of the storage unit.

17. The saddle bag according to claim 13, further comprising:
small-sized storage units independent of the storage unit, disposed in a gap between the case unit and an outside of the storage unit.

18. The saddle bag according to claim 15, wherein the small-sized storage units have openable lid portions.

19. A saddle bag for a motorcycle comprising the saddle bag according to claim 11, said vehicle being a motorcycle.

20. The saddle bag according to claim 19, wherein the storage unit includes a pair of saddle bags that slidingly open laterally in a vehicle lateral direction.
